(19) United States
(12) Patent Application Publication
(10) Pub. No.: US 2011/0082832 A1
(43) Pub. Date: Apr. 7, 2011

(54) PARALLELIZED BACKUP AND RESTORE PROCESS AND SYSTEM

(76) Inventors: RAMKUMAR VADALI, Mountain View, CA (US); Brent Chun, Rosemead, CA (US)

(21) Appl. No.: 12/573,164

(22) Filed: Oct. 5, 2009

(51) Int. Cl. G06F 12/16; G06F 12/00

(52) U.S. Cl. 707/615; 711/E12.001; 711/E12.103

(57) ABSTRACT

A system and methods for parallelized backup and restore process and system are disclosed. In one embodiment, a method includes providing a massively parallelized analytic database, serializing a schedule of a transaction history of the massively parallelized analytic database, and creating a transactionally consistent copy of the massively parallelized analytic database. The method may include restoring one or more of an original system and a configurationally equivalent system to a transaction consistent state as of a time the transactionally consistent copy was created. The transactionally consistent copy may be stored on a separate system than the original system. Accessibility to the transactionally consistent copy may be retained on the separate system even when the original system is inaccessible by the storing of the transactionally consistent copy on the separate system.

### FIELD OF TECHNOLOGY

This disclosure relates generally to a field of software technology and associated hardware, and more particularly to a parallelized backup and restore processes and systems.

### BACKGROUND

A state of a database that results from a serializable schedule of a transaction history can be referred to as being in a ‘transactionally consistent state’. It may be difficult to create a transactionally consistent copy of a massively parallelized analytic database (e.g., the nCluster® Database by Aster Data Systems, Inc.). Databases (e.g., the nCluster® Database) may be configurationally equivalent if they have the same number of virtual worker nodes. However, it may be difficult to restore an original system and/or restore a configurationally equivalent system to the transactionally consistent state as of a time a copy was made.

### SUMMARY

Several methods and a system for a parallelized backup and restore processes and systems are disclosed. In one embodiment, a method includes providing a massively parallelized analytic database, serializing a schedule of a transaction history of the massively parallelized analytic database, and creating a transactionally consistent copy of the massively parallelized analytic database.

The method may include restoring one or more of an original system and a configurationally equivalent system to a transaction consistent state as of a time the transactionally consistent copy was created. The transactionally consistent copy may be stored on a separate system than the original system. Accessibility to the transactionally consistent copy may be retained on the separate system even when the original system is inaccessible by the storing of the transactionally consistent copy on the separate system.

The creation of the transactionally consistent copy and the restoration of the transactionally consistent state may be parallelized to ensure that performance of backup and restore processes of the massively parallelized analytic database are scalable. The restoration of the transactionally consistent state may be streamlined through a direct application of a latest incremental backup. The restoration may be efficient because a copy of files may be a primary means of resorting data rather than a transaction log entry roll forward.

A file level copy may be employed during the creation of the transactionally consistent copy. In addition, a file system monitoring method may be used during the creation of the transactionally consistent copy to determine whether files have changed so that a minimum set of files are copied during the backup process. A time stamp may be used to determine which files have not changed. The time stamp may be pegged to a past point in time such that the time stamp is controllable and emulates a version number. Hard links may be used to point the files that have not changed since last backup so that the restore process begins with restoring the latest backup. The time stamp may be applied on a destination server to only successfully transferred files. The time stamp may be applied on a source server only when a file has been recently changed.

Further, the creation of the transactionally consistent copy and the restoration of the transactionally consistent state may be fail-safe in that they are pausable and resumable during backup and restoration processes. An auto-sensing mechanism may be applied to determine a most-efficient method to allocate resources when performing a compression operation and a decompression operation. The backup and restoration processes may be external to a PostGres instance in that an interaction between the backup and restore processes and PostGres instances may be through a published PostGres backup/recovery interface.

In another embodiment, a system includes a production cluster to process queries and a Data Manipulation Language (DML). The system also includes a backup cluster with a number of physical worker nodes on a different rack than the production cluster to backup and restore multiple production clusters thereby creating a centralized system to manage backups from all production systems.

The backup cluster may include at least five physical worker nodes, and one of the physical worker nodes may be a manager node. The production cluster may include eighty virtual worker nodes which are each a PostGres instance and one of the virtual worker nodes may be a queen node.

A backup process in the production cluster may begin with a control phase in which the manager node and the queen node communicate with each other to assign the virtual worker nodes to the physical worker nodes in a round-robin manner. The assigned ones of the virtual worker nodes may subsequently communicate with their assigned physical worker nodes directly, during a file transfer and a log transfer.

The backup process may determine which files are to be copied through a comparison of time stamps of a file system. The file changes may be monitored to streamline incremental backups by registering with the file system. The file transfer and the log transfer may be copied in parallel from the production cluster to the backup cluster, and a compression auto-sensing technique may be used to make best use of network and processor resource trade-off. Further, a quiescent mode may be entered by the production cluster after a best-effort attempt to copy all changed files, and transaction commits may be blocked in the quiescent mode.

The file time stamp comparison algorithm first initializes files' with a past time stamp, ptimestamp. A file's time stamp is updated when it's changed. When determining which files have changed, the backup process includes those files whose time stamp is not ptimestamp. Then, a new past time stamp, nptimestamp, is acquired and all transferred files' time stamp is set to nptimestamp on the destination backup cluster.

When PostGres instances are placed into a hot backup mode, a set of files that changed between when the backup process began and a time immediately after the quiescent mode is determined may be copied in parallel. The transaction logs may be copied and the production cluster may be taken out of the quiescent mode.

During a restore process of the production cluster, a massively parallel analytic database that is configurationally equivalent to an original system may be available to restore a full backup and/or an incremental backup of the original system. A manager node of the backup cluster and a queen node of the production cluster may communicate with each other to establish a correspondence between virtual worker nodes of the production cluster and physical worker nodes of the backup cluster.

The files in a backup file set may be copied in parallel to appropriate virtual worker nodes during the restore process. An auto-sensing mechanism may be employed to perform a file decompression using a most efficient resource allocation method. The logs in a backup log set may be copied in parallel to appropriate virtual nodes of the production cluster and to the queen node of the production cluster. The massively parallel analytic database may be brought up and PostGres instances on the virtual worker nodes of the production cluster may go through transaction recovery until the massively parallel analytic database is fully restored.

In yet another embodiment, a machine readable medium providing instructions, which when read by a processor causes the machine to perform operations that includes providing a massively parallelized analytic database, serializing a schedule of a transaction history of the massively parallelized analytic database, creating a transactionally consistent copy of the massively parallelized analytic database, and restoring one of an original system and/or a configurationally equivalent system to a transaction consistent state as of a time the transactionally consistent copy was created.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a systematic view illustrating a communication between a production cluster and backup cluster through a network, according to one embodiment.

FIG. 2 is diagrammatic view illustrating a full backup set and an incremental backup set, according to one embodiment.

FIG. 3 is a diagrammatic system view of a data processing system in which any of the embodiments disclosed herein may be performed, according to one embodiment.

FIG. 4A is a process flow illustrating a parallelized backup and restore process, according to one embodiment.

FIG. 4B is a continuation of the process flow illustrated in FIG. 4A illustrating additional operations, according to one embodiment.

Other features of the present embodiments will be apparent from the accompanying drawings and from the detailed description that follows.

### DETAILED DESCRIPTION

Several methods and a system for parallelized backup and restore processes and systems are disclosed. Although the present embodiments have been described with reference to specific example embodiments, it will be evident that various modifications and changes may be made to these embodiments without departing from the broader spirit and scope of the various embodiments.

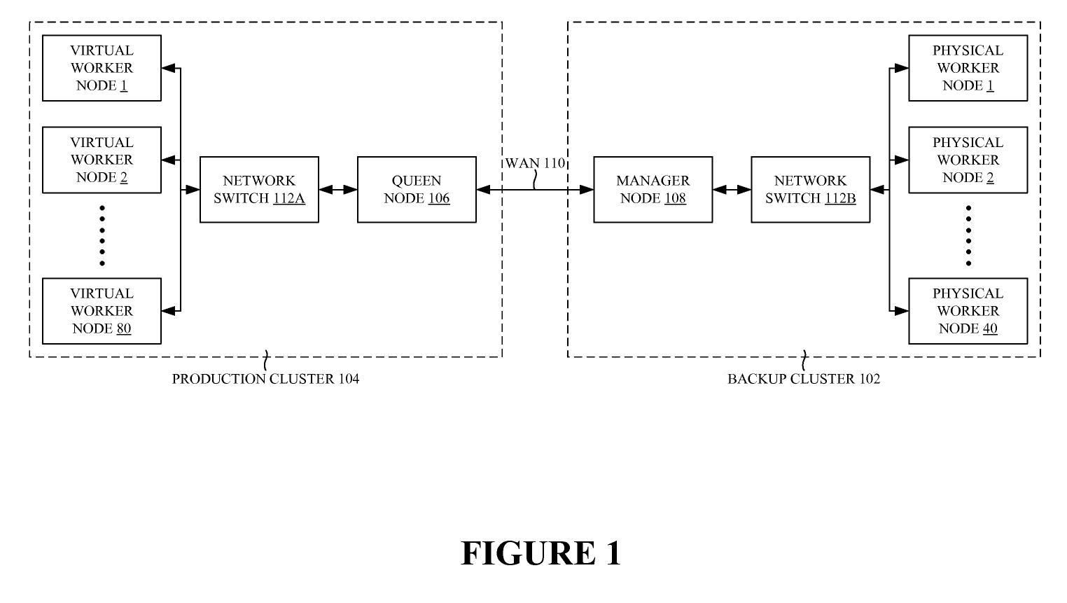

FIG. 1 is a systematic view illustrating a communication between a production cluster and backup cluster through a network, according to one embodiment.

In one embodiment, a back up cluster 102 may include up to a pre-defined maximum number of physical worker node, maxPWN, (e.g., physical worker node 1-maxPWN) in which one of a physical worker node may be a manager node 108. The backup cluster 102 may be located on a different rack than the original system so that a failure of the original system may not render the backup inaccessible. A network switch 112 B may connect the multiple physical worker nodes and the manager node 108 together within one Local Area Network (LAN). The network Switch 112 B may inspect the data packets as they are received, determine the source and destination of each data packet and forward them appropriately. Further, the backup cluster 102 may be used to backup and/or restore multiple production clusters thereby creating a centralized system to manage backups from all production systems.

In another embodiment, a production cluster 104 may include up to pre-defined number of virtual worker nodes, maxVWN (e.g., virtual worker node 1-maxVWN) in which each virtual worker node may be a PostGres instance. Any one of the virtual worker nodes may be a queen node 106. A network switch 112 A may connect the multiple virtual worker nodes and the queen node 106 together within one Local Area Network (LAN). A backup of production cluster 104 may be obtained by processing queries and a Data Manipulation Language (DML). The DML may be a computer language used by a data base user to manipulate (e.g., retrieve, update, insert, delete, etc.) a database.

In one or more embodiments, the backup process may be initiated with the a control phase in which the manager node 108 and the queen node 106 may communicate with each other to assign the virtual worker nodes (e.g., the virtual worker node 1-maxVWN) to the physical worker nodes (e.g., the physical worker node 1-maxPWN) in a round-robin manner. The manager node 108 and the queen node 106 may communicate through a Wide Area Network (WAN) 110. The virtual worker node 1-maxVWN may subsequently communicate with their assigned physical worker nodes directly during a file transfer and/or a log transfer. The backup process may determine a set of files to be copied by comparing time stamps of a file system. The changes to the files may be monitored by streamlining incremental backups to register with the file system.

In another embodiment, the file transfer and the log transfer may be copied in parallel from the production cluster 104 to the backup cluster 102 and a compression auto-sensing technique may be used to make best use of network and processor resource trade-off. After a best-effort to copy all the changed files, the production cluster 104 may enter into a quiescent mode and may block transaction commits in the quiescent mode. Then, the PostGres instances may be placed into a hot-backup mode. A set of file that changed between when the backup process began and a time immediately after the quiescent mode is determined may be copied in parallel. Subsequently, the transaction logs may be copied and the production cluster 104 may be taken out of the quiescent mode.

A single backup cluster can be used to backup and/or restore multiple production clusters. A failure of any production system (e.g., the production cluster 104) may be recovered from a backup taken from the failed system. In one embodiment, during a restoring process of the production cluster 104, a massively parallel analytic database (e.g., the nCluster® Database by Aster Data Systems, Inc.) that is configurationally equivalent to an original system may be made available to restore a full backup and/or an incremental backup of the original system. The manager node 108 may communicate with the queen node 106 to establish a correspondence between the virtual worker node 1-maxVWN of the production cluster 104 and the physical worker node 1-maxPWN of the backup cluster 102.

Further, the files in a backup file set may be copied in parallel to the appropriate virtual worker nodes. An auto sensing mechanism may be used to perform a file decompression using a most efficient resource allocation method. The logs in the backup log set may be copied in parallel to the appropriate virtual worker nodes of the production cluster 104 and to the queen node 106 of the production cluster 104. The massively parallel analytic database may be brought up and PostGres instances on the virtual worker node 1-maxVWN of the production cluster 104 may go through transaction recovery until the massively parallel analytic database is fully restored.

According to one embodiment, the backup process may include two separate phases, best effort phase and consistent phase. In the best effort phase, the files that have been changed since the previous backup may be copied without restricting transaction commit. For example, the best effort phase may copy files of virtual worker node 1-maxVWN and the queen node 106 in parallel. The consistent phase may follow the best effort phase after disabling transaction commit.

In the consistent phase the transaction commits may be blocked initially. Then, a postGres instance of each virtual worker node may be placed into a hot backup mode. Further, the files that have changed since the beginning of the best effort phase may be determined and the changed files may be copied in parallel. The postGres instance may be taken out of the hot backup mode and the postGres transaction log files are copied. Furthermore, a consistent copy of the queen node 106 may be created. Again, postGres instance may be placed into the hot backup mode and the files that have changed since the beginning of the best effort phase may be determined and the changed files may be copied in parallel. The postGres instance may be taken out of the hot backup mode and the postGres transaction log files are copied and then the transaction commit may be allowed.

According to another embodiment, the restore process may initially restore the virtual worker node 1-maxVWN by copying the files and transaction logs from a backup file set and the files may be decompressed in parallel. Next, the queen node 106 may be restored by copying the files and transaction logs from a backup file set and the files may be decompressed in parallel. After restoring and decompressing the files the production cluster 104 may be restarted and the in-doubt transactions may be resolved. Furthermore, the postGres instance may go through transaction recovery to rollforward/rollback the in-doubt transactions.

As mentioned above, in the consistent phase the files may be copied after disabling the transaction commit and placing a postGres into a hot backup mode, these files may include changes for all transactions committed before the beginning of the consistent phase. As the transaction logs are copied after the PostGres instance is taken out of the hot backup mode, the copied transaction logs may contain log entries pertaining to changes made by un-committed transactions. Since PostGres supports two phase commit, the PostGres transaction recovery may be performed efficiently. The restore process may place the production cluster 104 into the transaction consistent state. The transaction consistent state may be the state of the database that results from a serializable schedule of the transaction history. When restoring to the original system, it may be that not all files are copied (Only files that have changed are copied).

In an example embodiment, the recovery system may be illustrated with respect to time slot. At time ‘0’ the consistent phase may be initiated and the transaction commit may be disabled. At time ‘1’ an update statement may change data blocks (e.g., files) and transaction log entries may be generated. At time ‘2’ PostGres instance may be put in the hot backup mode. Next, at time ‘3’ the files reflecting the changes may be determined. At time'4′ PostGres instance may be taken out of the hot backup mode and the transaction logs may be removed. At time ‘5’ the PostGres transaction logs containing the log entries from the updated statement may be copied to an appropriate virtual worker node and at time ‘6’ the transaction commit may be enabled. At time ‘7’ a production cluster may fail. Next, at time ‘8’ the restore process may copy the files and logs from the backup set and at time ‘9’ the production cluster may be restarted. At time ‘10’ the production cluster may go through transaction recovery process. The changes from the updated statement may be rolled back from the transaction log.

In one embodiment, the parallelized backup and/or restore mechanism may include creating a transactionally consistent copy of an online production cluster (e.g., massively parallelized analytic database). A schedule of a transaction history of the production cluster may be serialized. Serialization may include converting the files of the transaction history into sequence of bits so that it can be persisted with the storage medium. The transactionally consistent copy may be used to restore an original system. Also, the transactionally consistent copy may be used to restore a configurationally equivalent system to the transactionally consistent state as of the time the transactionally consistent copy was created. The transaction consistent state may be a state of the database that may result from a serializable schedule of the transaction history. The configutrationally equivalent system may be system that may have the same number of virtual worker nodes.

In another embodiment, the backup and restore system may be unique in its architecture. The backup may be stored on a separate system than the original system so that a failure of the original system may not render the backup inaccessible. The backup and restore processes may be parallelized so that the performance is scalable. In both the backup and restore system, an auto-sensing mechanism may be used to determine the most efficient method to allocate resources to perform file compression operation and/or file decompression operation. The restore process may be streamlined by directly applying the latest incremental backup. The restore process may be efficient because a copy of files may be a primary means of restoring data rather log entry roll forward. The backup process may employ a file level copy during the creation of the transactionally consistent copy.

In addition, the backup process may be efficient in that file system monitoring method may be used to determine the files changed so that a minimum set of files are copied. The creation of transactionally consistent copy and the restoration of the transactionally consistent state may be fail-safe in that they may be paused and/or resumed during backup and/or restoration process. The backup/restore process is paused when network transmission is terminated. The backup/restore process is resumed after redoing file timestamp comparison. The backup and/or restore mechanism may be external to the PostGres instances in that the interactions between the backup and restore processes and PostGres instances are through published ProstGres backup/recovery interface.

In another embodiment, the backup/restore process may be resumed after a pause caused by failures. The backup/restore process may record files/logs that have been successfully copied and files/logs that still need to be copied. After a pause, the backup/restore process may resume from the file/log that was being copied when the failure occurred.

The backup/restore process may interact with PostGres only through the PostGres backup/recovery interface. Specifically, the backup/restore process may rely on the PostGres backup/recovery performance. The PostGres backup/recovery performance may include placing PostGres instance into a hot-backup mode. Taking PostGres into hot backup mode may result in a new checkpoint, for which, all modified data is flushed to files and the transaction log is truncated. PostGres transaction recovery may supports 2-Phase commit in that prepared transactions that do not appear in the coordinator's commit list may be aborted. A sufficient condition for PostGres transaction recovery may be the presence of all database files having changes made prior to the latest checkpoint and the transaction log entries of all un-committed transactions.

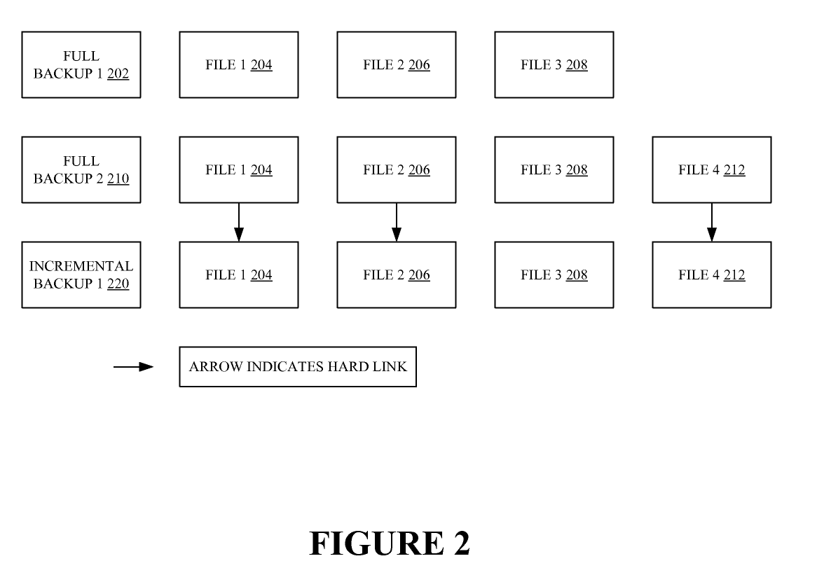

FIG. 2 is diagrammatic view illustrating a full backup set and an incremental backup set, according to one embodiment. In one embodiment, FIG. 2 illustrates three backup sets from the same production cluster (e.g., the production cluster 104 of FIG. 1). The three back upsets may be created in the chronological order of: full backup 1 202, full backup 2 210 and incremental backup 1 220. The backup set, full backup 1 202 may include a file 1 204, a file 2 206 and a file 3 208 of the production cluster 104. The backup set, full backup 2 210 may include a new file, file 4 212 in addition to all the files in the first backup set (e.g., full backup 1 202). The incremental backup 1 220 may include three hard links to files in full backup 2 210 and a copy of file 3 208. The hard links may indicate that the file 1 205, file 2 206 and file 4 212 have not changed since full backup 2 210 was created, whereas the file 3 208 has changed. The incremental backup set 1 220 may include hard links to files in the previous backup sets. The hard links may be indicated by the arrows as illustrate in FIG. 2. When restoring the latest backup, the restore process may copy all files in the backup set treating hard links as a regular file. A time stamp may be used to determine which files have not changed. The time stamp may be pegged to a past point in time such that the time stamp is controllable and emulates a version number. The time stamp may be applied on a destination server to only successfully transferred files. The time stamp may be applied on a source server only when a file has been recently changed.

According to one embodiment, during backup process the set of files to be copied may be determined. All the transaction files may be copied in a full backup set. Then the files that have changed since the last backup may be copied in an incremental backup. Hard links may be made to the files (e.g., as illustrated in FIG. 2) that have not changed. In addition, the changed files may be determined by comparing time stamps of a file system and file changes may be monitored to streamline incremental backups by registering to the file system.

The backup and restore processes may be made scalable by parallelizing the time consuming processing stages. Processing stages that are parallelized may include file copy during backup, transaction log copy during backup, file copy during restore, and transaction log copy during restore.

When copying the files during backup process, each production cluster node may transfer files belonging to its virtual worker nodes directly to the physical worker nodes assigned to it. While copying transaction log during backup process each virtual worker node of the production cluster 104 may transfer transaction logs directly to the physical worker node assigned to it. During restore process each physical worker node may transfer the stored files directly to the virtual worker node assigned to it. While copying transaction logs during restore process each physical worker node may transfer transaction logs stored locally directly to the virtual worker nodes assigned to it. The parallelized processing may enable the time taken for a backup/restore operation to scale with a number of physical worker nodes in the backup cluster 102 and/or virtual worker nodes in the production cluster 104.

Files may be compressed before they are stored in the backup set (e.g., the file backup 1 202, the file backup 2 210, and the incremental backup 1 220). Files may be decompressed before they are restored on the target virtual worker node (e.g., virtual worker node 1-maxVWN). Determining when to perform compression/decompression may be optimized to minimize the communication time and the CPU time given the current communication bandwidth and CPU utilization.

The backup/restore process may perform the optimization by monitoring the communication bandwidth usages and CPU utilization history, then, heuristically enumerating the search space of feasible compression/decompression schedules.

The restore process may start from full and/or incremental backup. Restoration may be a streamlined process compared to Relational database management system (RDBMS). The restore process of RDBMS may have to start with the restore of a full backup followed by restoration of each incremental backup up to the latest one.

The restore process may be efficient compared to roll forward based recovery mechanisms employed by the RDBMS. The restore process may involve file copying and/or log copying but not time consuming log roll forward operations. In a roll forward based recovery mechanism, archived transaction logs are first copied, the transaction log entries are re-applied, checkpoints are taken and un-committed transactions are rolled back. As log entries are commonly physio-logical, the redo operations may be very CPU intensive and time consuming. Moreover, a new full backup may be required after the recovery process. If the restore process is initiated to a cluster that had been previously restored from backup, the restore process may copy only those files that have differing time stamps from the backup.

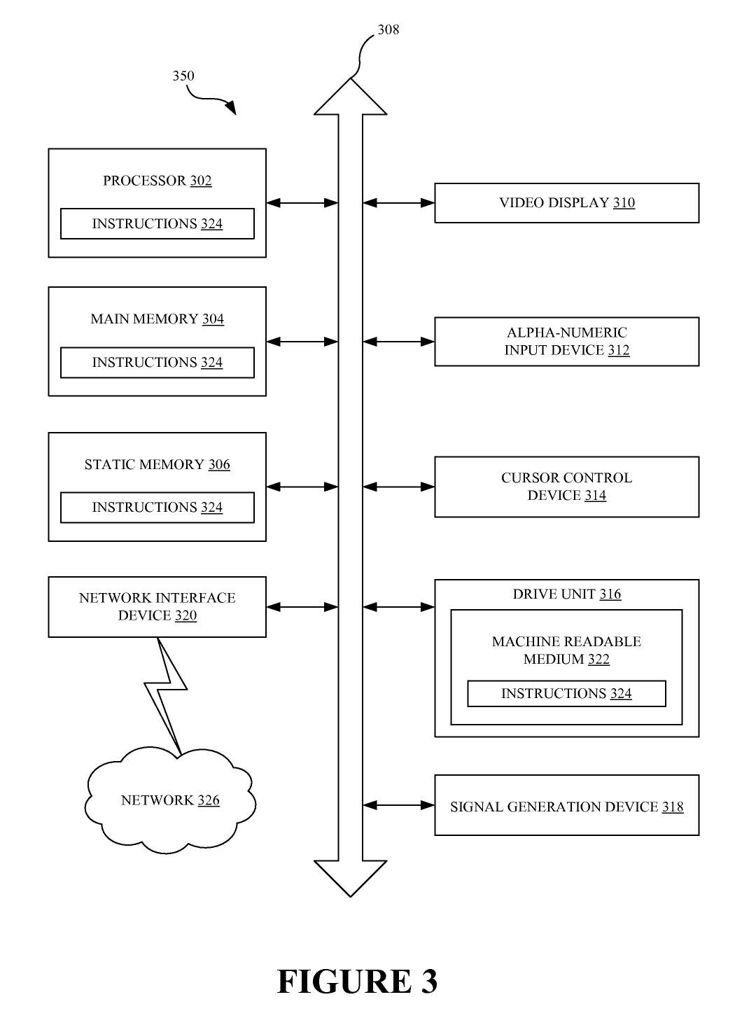

FIG. 3 is a diagrammatic system view of a data processing system in which any of the embodiments disclosed here in may be performed, according to one embodiment. Particularly, the diagrammatic system view 300 of FIG. 3 illustrates a processor 302, a main memory 304, a static memory 306, a bus 308, a video display 310, an alpha-numeric input device 312, a cursor control device 314, a drive unit 316, a signal generation device 318, a network interface device 320, a machine readable medium 322, instructions 324, and a network 326, according to one embodiment.

The diagrammatic system view 300 may indicate a personal computer and/or the data processing system in which one or more operations disclosed herein are performed. The processor 302 may be a microprocessor, a state machine, an application specific integrated circuit, a field programmable gate array, etc. (e.g., Intel® Pentium® processor). The main memory 304 may be a dynamic random access memory and/or a primary memory of a computer system.

The static memory 306 may be a hard drive, a flash drive, and/or other memory information associated with the data processing system. The bus 308 may be an interconnection between various circuits and/or structures of the data processing system. The video display 310 may provide graphical representation of information on the data processing system. The alpha-numeric input device 312 may be a keypad, a keyboard and/or any other input device of text (e.g., a special device to aid the physically handicapped).

The cursor control device 314 may be a pointing device such as a mouse. The drive unit 316 may be the hard drive, a storage system, and/or other longer term storage subsystem. The signal generation device 318 may be a bios and/or a functional operating system of the data processing system. The network interface device 320 may be a device that performs interface functions such as code conversion, protocol conversion and/or buffering required for communication to and from the network 326. The machine readable medium 322 may provide instructions on which any of the methods disclosed herein may be performed. The instructions 324 may provide source code and/or data code to the processor 302 to enable any one or more operations disclosed herein.

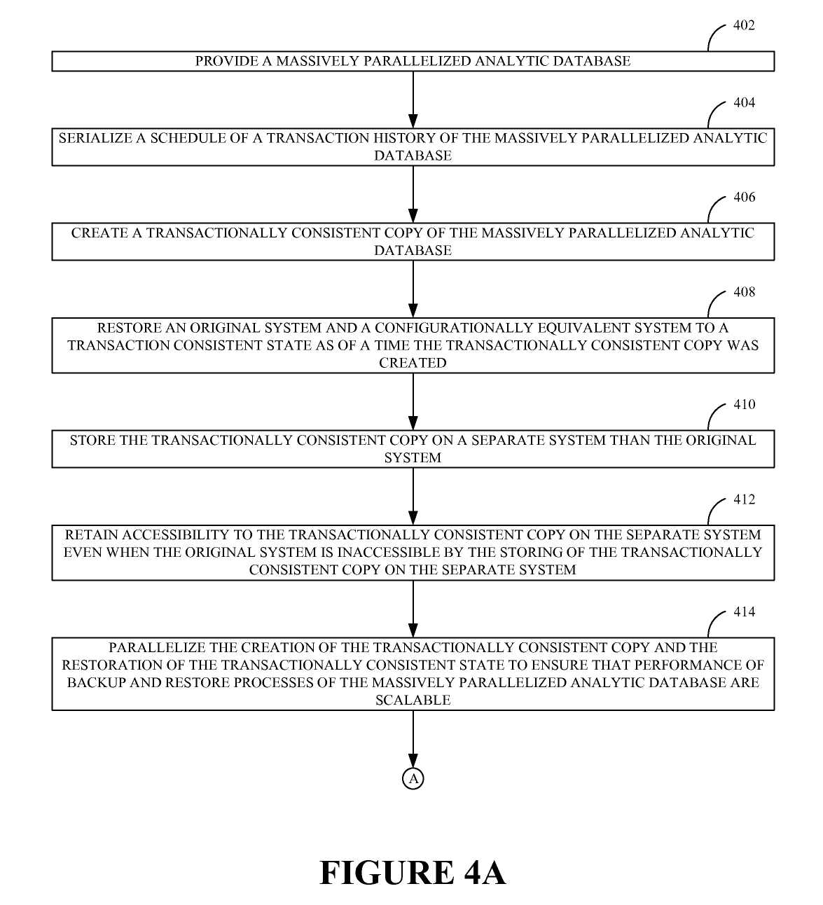

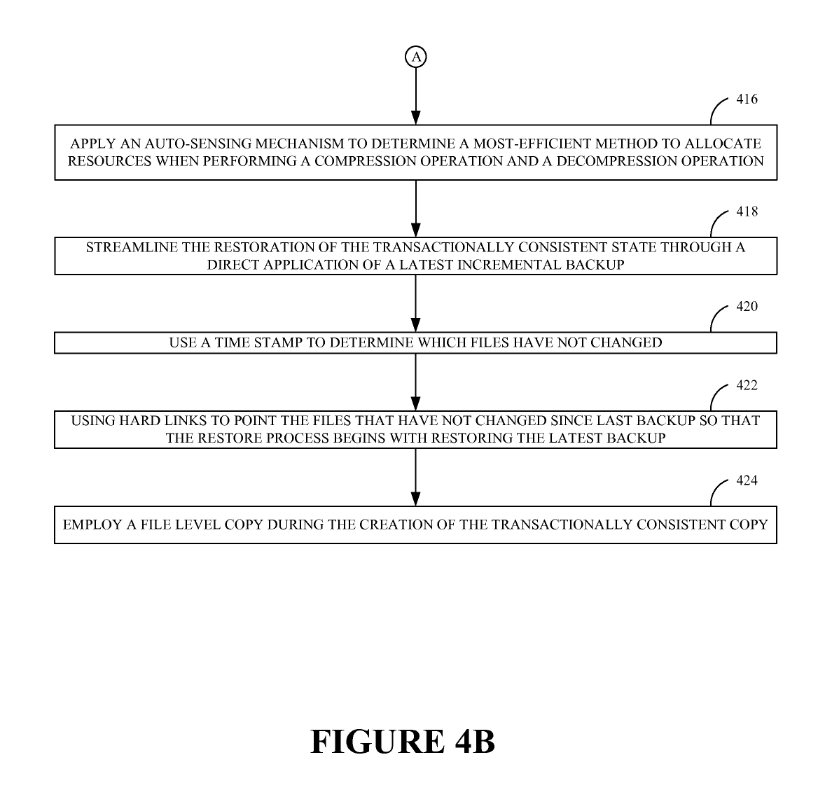

FIG. 4A is a process flow illustrating a parallelized backup and restore process, according to one embodiment. In operation 402, a massively parallelized analytic database (e.g., the nCluster® Database by Aster Data Systems, Inc.) may be provided. In operation 404, a schedule of a transaction history of the massively parallelized analytic database may be serialized. In operation 406, a transactionally consistent copy of the massively parallelized analytic database may be created. In operation 408, an original system and/or a configurationally equivalent system may be restored to a transaction consistent state as of a time the transactionally consistent copy was created. The transaction consistent state may be a state of the database that may result from a serializable schedule of the transaction history. The configurationally equivalent system may be system that may have the same number of virtual worker nodes.

In operation 410, the transactionally consistent copy may be stored on a separate system (e.g., the backup cluster 102) than the original system. In operation 412, accessibility to the transactionally consistent copy may be retained on the separate system even when the original system is inaccessible by the storing of the transactionally consistent copy on the separate system. In operation 414, the creation of the transactionally consistent copy and the restoration of the transactionally consistent state may be parallelized to ensure that performance of backup and restore processes of the massively parallelized analytic database are scalable. For example, the paralleized processing may enable the backup/restore operation to scale with the number of physical worker nodes in the backup cluster 102 and the virtual worker nodes in the production cluster 104.

FIG. 4B is a continuation of the process flow illustrated in FIG. 4A illustrating additional operations, according to one embodiment. In operation 416, an auto-sensing mechanism may be applied to determine a most-efficient method to allocate resources when performing a compression operation and a decompression operation. For example, the auto-sensing technique may be used to make best use of network and processor resource trade-off. In operation 418, the restoration of the transactionally consistent state may be streamlined through a direct application of a latest incremental backup. For example, the incremental backup 1 220 may be monitored by registering with the file system. In operation 420, a time stamp may be used to determine which files have not changed. In operation 422, hard links may be used to point the files that have not changed since last backup so that the restore process begins with restoring the latest backup (e.g., as illustrated in FIG. 2). In operation 424, a file level copy may be employed during the creation of the transactionally consistent copy.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method, comprising:
providing a massively parallelized analytic database;
serializing a schedule of a transaction history of the massively parallelized analytic database; and
creating a transactionally consistent copy of the massively parallelized analytic database.

2. The method of claim 1 further comprising:
restoring at least one of an original system and a configurationally equivalent system to a transaction consistent state as of a time the transactionally consistent copy was created.

3. The method of claim 2 further comprising:
storing the transactionally consistent copy on a separate system than the original system; and
retaining accessibility to the transactionally consistent copy on the separate system even when the original system is inaccessible by the storing of the transactionally consistent copy on the separate system.

4. The method of claim 2 further comprising parallelizing the creation of the transactionally consistent copy and the restoration of the transactionally consistent state to ensure that performance of backup and restore processes of the massively parallelized analytic database are scalable.

5. The method of claim 2 further comprising applying an auto-sensing mechanism to determine a most-efficient method to allocate resources when performing at least one of a compression operation and a decompression operation.

6. The method of claim 2 further comprising streamlining the restoration of the transactionally consistent state through a direct application of a latest incremental backup.

7. The method of claim 2 wherein the restoration is efficient because a copy of files is a primary means of restoring data rather than a transaction log entry roll forward.

8. The method of claim 2 wherein the creation of the transactionally consistent copy and the restoration of the transactionally consistent state are fail-safe in that they are pausable and resumable during backup and restoration processes.

9. The method of claim 2 further comprising:
using a time stamp to determine which files have not changed, wherein the time stamp is pegged to a past point in time such that the time stamp is controllable and emulates a version number; and
using hard links to point the files that have not changed since last backup so that the restore process begins with restoring the latest backup,
wherein the time stamp is applied on a destination server to only successfully transferred files, and
wherein the time stamp is applied on a source server only when a file has been recently changed.

10. The method of claim 8 wherein the backup and restoration processes are external to a PostGres instance in that an interaction between the backup and restore processes and PostGres instances are through a published PostGres backup/recovery interface.

11. The method of claim 1 further comprising employing a file level copy during the creation of the transactionally consistent copy.

12. The method of claim 10 further comprising wherein a file system monitoring method is used during the creation of the transactionally consistent copy to determine whether files have changed so that a minimum set of files are copied during the backup process.

13. A system comprising:
a production cluster to process queries and a Data Manipulation Language (DML); and
a backup cluster with a number of physical worker nodes on a different rack than the production cluster to backup and restore multiple production clusters thereby creating a centralized system to manage backups from all production systems.

14. The system of claim 13 wherein the backup cluster comprises at least five physical worker nodes, and wherein at least one of the physical worker nodes is a manager node.

15. The system of claim 13 wherein the production cluster comprises eighty virtual worker nodes which are each a PostGres instance, and wherein at least one of the virtual worker nodes is a queen node.

16. The system of claim 14 wherein a backup process in the production cluster begins with a control phase in which the manager node and the queen node communicate with each other to assign the virtual worker nodes to the physical worker nodes in a round-robbin manner, and wherein assigned ones of the virtual worker nodes subsequently communicate with their assigned physical worker nodes directly during at least one of a file transfer and a log transfer.

17. The system of claim 15 wherein the backup process determines which files are to be copied through a comparison of time stamps of a file system, and wherein file changes are monitored to streamline incremental backups by registering with the file system.

18. The system of claim 16 wherein the file transfer and the log transfer are copied in parallel from the production cluster to the backup cluster, and a compression auto-sensing technique is used to make best use of network and processor resource trade-off.

19. The system of claim 17 wherein a quiescent mode is entered by the production cluster after a best-effort attempt to copy all changed files, and wherein transaction commits are blocked in the quiescent mode.

20. The system of claim 18 wherein when PostGres instances are placed into a hot backup mode, a set of files that changed between when the backup process began and a time immediately after the quiescent mode is determined and copied in parallel.

21. The system of claim 19 wherein transaction logs are copied and the production cluster is taken out of the quiescent mode.

22. The system of claim 12 wherein during a restore process of the production cluster, a massively parallel analytic database that is configurationally equivalent to an original system is made available to restore at least one of a full backup and an incremental backup of the original system.

23. The system of claim 21 wherein a manager node of the backup cluster and a queen node of the production cluster to communicate with each other to establish a correspondence between virtual worker nodes of the production cluster and physical worker nodes of the backup cluster.

24. The system of claim 22 wherein files in a backup file set are copied in parallel to appropriate virtual worker nodes during the restore process, and wherein an auto-sensing mechanism is used to perform a file decompression using a most efficient resource allocation method.

25. The system of claim 23 wherein logs in a backup log set are copied in parallel to appropriate virtual nodes of the production cluster and to the queen node of the production cluster.

26. The system of claim 24 wherein the massively parallel analytic database is brought up and PostGres instances on the virtual worker nodes of the production cluster goes through transaction recovery until the massively parallel analytic database is fully restored.

27. A machine-readable medium providing instructions, which when read by a processor, cause the machine to perform operations, comprising:
providing a massively parallelized analytic database;
serializing a schedule of a transaction history of the massively parallelized analytic database;
creating a transactionally consistent copy of the massively parallelized analytic database; and
restoring at least one of an original system and a configurationally equivalent system to a transaction consistent state as of a time the transactionally consistent copy was created.

28. The machine-readable medium of claim 27 further comprising:
storing the transactionally consistent copy on a separate system than the original system; and
retaining accessibility to the transactionally consistent copy on the separate system even when the original system is inaccessible by the storing of the transactionally consistent copy on the separate system.

29. The machine-readable medium of claim 27 further comprising: parallelizing the creation of the transactionally consistent copy and the restoration of the transactionally consistent state to ensure that performance of backup and restore processes of the massively parallelized analytic database are scalable.

30. The machine-readable medium of claim 27 further comprising: applying an auto-sensing mechanism to determine a most-efficient method to allocate resources when performing at least one of a compression operation and a decompression operation.

31. The machine-readable medium of claim 27 further comprising: streamlining the restoration of the transactionally consistent state through a direct application of a latest incremental backup.
